(19) United States
(12) Patent Application Publication
(10) Pub. No.: US 2006/0130403 A1
(43) Pub. Date: Jun. 22, 2006

(54) Selectively removable non-egress window for transit motor vehicles

(76) Inventors: Brad G. Krehbiel, Brewton, AL (US); Joseph Randell Miller, Evergreen, AL (US)

Correspondence Address: BAKER, DONELSON, BEARMAN,;CALDWELL & BERKOWITZ, P.C., 5 CONCOURSE PARKWAY, STE. #900, ATLANTA, GA, 30328, US

(21) Appl. No.: 11/022,320

(22) Filed: Dec. 22, 2004

(51) Int. Cl. E05B 65/10

(52) U.S. Cl. 49/141

(57) ABSTRACT

A non-egress window for motor vehicles selectively removable for servicing, in which an exterior frame having a connector mounts in an opening in a sidewall of a motor vehicle and a window frame with a window pane attaches to the connector. A pair of latch keepers mount in spaced-apart relation to the exterior frame opposing the connector. A release bar in the exterior frame opposing the connector selectively moves between a first position and a second position relative to the latch keepers by a tool selectively brought into contact with the release bar. A pair of latch catchers attached to the release bar engages the latch keepers with the release bar in the first position and disengage from the latch keepers with the release bar in a second position. A method of removing a non-egress window from a motor vehicle is disclosed.

### TECHNICAL FIELD

The present invention relates to windows for transit motor vehicles. More particularly, the present invention relates to a non-egress window readily removable from a transit motor vehicle for servicing.

### BACKGROUND OF THE INVENTION

Transit motor vehicles such as buses, trolleys, transit rail cars, and other such motor vehicles typically are configured with a number of seats for transporting a large number of passengers, as compared to conventional cars. The sidewalls of the transit motor vehicle include a number of openings for entrance doors and windows. Typically the windows mount in openings on opposing longitudinal sides of the motor vehicle. The windows have an exterior window frame that attaches to the sidewall of the motor vehicle. An interior window frame with glazing attaches to the exterior frame and is secured thereto. The sidewall windows are either egress-type windows or non-egress type windows. “Egress” windows include a handle or other release actuator whereby the window can be opened relative to the sidewall of the motor vehicle for emergency egress by passengers. On the other hand, “non-egress” windows are secured within the exterior frame by an interior trim frame fastened with screws to the interior wall of the motor vehicle.

Because transit motor vehicles are expensive to own and operate, maintenance downtime can become a significant cost factor in operating the transmit motor vehicle. For example, damage to windows require replacement of the window. For an egress-type window, replacement is readily accomplished by moving the handle to disengage the window from the exterior frame and pushing the window frame outwardly relative to the frame. The egress window is then readily removed from engagement to the exterior frame, typically by detaching a pivotable connection of the window frame to the exterior frame.

On the other hand, removal of non-egress type windows is significantly more challenging, and can become a time consuming activity due to the number of screws securing the trim frame that must be removed. The time and labor involved in removing and reinstalling the window and trim frame, together with the downtime, results in significant labor and productivity costs.

Accordingly, there is a need in the art for a readily removable non-egress window for transmit motor vehicles. It is to such that the present invention is directed.

### SUMMARY OF THE PRESENT INVENTION

The present invention meets the need in the art by providing a non-egress window for motor vehicles selectively removable for servicing, comprising an exterior frame for mounting in an opening in a sidewall of a motor vehicle. A connector attaches to the exterior frame. A window frame selectively attaches to the connector and includes a glazing that holds a windowpane. A pair of latch keepers mounts in spaced-apart relation to the exterior frame opposing the connector. A release bar mounts in the exterior frame opposing the connector and selectively moves between a first position and a second position relative to the latch keepers by a tool selectively brought into contact with the release bar. A pair of latch catchers attached to the release bar engages the latch keepers with the release bar in the first position and disengage from the latch keepers with the release bar in a second position.

In another aspect, the present invention provides a method of removing a non-egress window from a sidewall of a motor vehicles for servicing, comprising the steps of:

(a) removing a cover that closes an opening in a window frame, which opening is aligned with a portion of a release bar mounted therein, the release bar having a latch catcher that in a first position is engaged with a latch keeper mounted to an exterior frame in an opening in a sidewall of a motor vehicle;

(b) contacting the release bar with a tool inserted through the opening;

(c) moving the release bar with the tool to a second position relative to the latch keeper to disengage the latch catcher; and

(d) pivoting the widow frame from the exterior frame.

Objects, advantages, and features of the present invention will become apparent upon reading the following detailed description in conjunction with the drawings and the appended claims.

### BRIEF DESCRIPTION OF THE DRAWINGS

FIG. 1 is a front elevational view non-egress windows according to the present invention mounted in a side wall of a transit vehicle.

FIG. 2 is a cross-section side elevational view of the non-egress window illustrated in FIG. 1 taken along line 2-2.

FIG. 3A is a cross-section side elevational view of the non-egress window illustrated in FIG. 1 taken along line 3A-3A.

FIG. 3B is a cross-section side elevational view of the non-egress window illustrated in FIG. 1 taken along line 3B-3B.

FIG. 4 is a detailed cut-away view of a lower frame of the non-egress window illustrated in FIG. 1.

FIG. 5 is a detailed cut-away side view of an actuator release for the non-egress window illustrated in FIG. 1.

FIGS. 6A, 6B, and 6C illustrate the operation of the actuator release for the non-egress window illustrated in FIG. 1.

FIGS. 7A and 7B illustrate the engagement of the non-egress window to a frame.

FIG. 8 illustrates a detailed view of an upper portion of the non-egress window hingedly connected to an outer frame attached to a sidewall of the transit vehicle.

### DETAILED DESCRIPTION

Referring now in more detail to the drawings, in which like parts have like identifiers, the present invention provides a non-egress window 10 readily removable for maintenance and service in a motor vehicle such as a transit bus having non-egress windows and egress windows mounted in openings in the sidewalls of the motor vehicle. The non-egress window 10 includes an inner window assembly 12 that detachably mounts in an outer frame 14. The outer frame 14 is secured in an opening in the sidewall 11 of the transit vehicle. The inner window assembly 12 in the illustrated embodiment includes an inner frame 15 that supports a stationary glass portion generally 16 and a pivotingly movable glass portion generally 18 separated by a divider bar 20. The outer frame 14 includes opposing upper and lower portions 22, 24 and opposing side portions 26a, 26b interconnected by arcute portions 28.

FIG. 2 illustrates the non-egress window 10 in cross-section side elevational view. The outer frame 14 assembles from elongate members 30. Each member 30 has an outward side 32 with opposing distal ends that define a mounting flange 34 at one end and a hook 36 at the opposing end. A seal 37 attaches on an inward surface of the mounting flange 34 and sealingly bears against an exterior sidewall of the motor vehicle. A cross-member 38 extends laterally intermediate the distal ends of the outward side 32 to an inward plate 40. The inward plate 40 defines a receiving channel 42 at a first distal end. An elongate seal 44 attaches to the plate 40 on an exterior-facing surface. Trim ring members 46 attach with screws to the receiving channel 42 to define an inward face of the outer frame 14. The member 30 and the trim ring member 46 cooperatively define a cap that overlies the edge of the sidewall defining the opening for the non-egress window 10.

At least one latch keeper 48 attaches to an upper surface of the cross member 38 of the member 30 that defines the lower portion 24 of the exterior frame 14. The illustrated embodiment includes a pair of spaced-apart latch keepers 48 mounted in spaced-apart relation. The latch keepers 48 are spring angle members that flexibly move downwardly towards the cross member 38 but are biased in an opposing upward direction.

The frame 15 of the inner window assembly 12 includes an elongate lower frame member 52 and an opposing elongate upper frame member 54 interconnected by opposing elongate side frame members and the divider bar 20. The lower frame member 52 includes an exterior plate 55 from which a base 56 extends laterally to an inner plate 58. The lower frame member 52 defines a recess that receives an elongated release bar 62. The release bar is movable longitudinally as discussed below. A latch catch 64 attaches to the release bar 62 for each latch keeper 48. The latch catch 64 includes a protrusion 66. A distal end of the protrusion engages the latch keeper 48 as discussed below. Glazing 70 holds an edge of a glass pane 72 within a channel 68. A seal member 74 attaches to an exterior face of the plate 54 and sealingly overlaps the exterior face of the exterior frame 16.

The opposing elongate upper frame member 54 includes an exterior plate 80 from which a base 82 extends laterally to an inner plate 84. The upper frame member 54 defines a recess that receives an elongate member 86 having a projecting hook 88. The hook 88 pivotally connects to the hook 36 of the upper exterior frame member 30, whereby the inner window assembly 12 pivotingly connects to the exterior frame 14. A latch keeper 90 attaches to a lower surface of the base 82 and defines a projecting lip 92. A seal member 94 attaches to an exterior face of the plate 80 and sealingly overlaps the exterior face 36. A seal member 95 attaches to an inward surface of the exterior plate 80.

The divider bar 20 is an elongate member having an exterior plate 100 and a laterally extending support 102 terminating in an interior plate 104. The exterior plate 100 defines a groove 106 in an inward face near a distal end. A channel 107 receives. glazing that holds the opposing upper edge of the glass pane 72.

The movable glass portion 18 pivotally connects with a transom 110 to the divider bar 20. The transom 110 includes a laterally extending ledge 112 that contacts the distal end of the exterior plate 100. A lower stub 114 extending from the ledge 112 engages the groove 106 in the divider bar 20. A channel receives glazing to hold a windowpane 118. A transom hinge 120 attaches to the interior plate 104 of the divider bar 20. A Z-shaped spring member 122 inserts between the transom hinge 120 and an inward edge of the transom 110. The spring member 122 supports the movable glass portion 18 when pivoted inwardly relative to the divider bar 20. A bumper strip 124 closes the gap between the transom hinge 120 and the transom 110.

A sash 130 defines a channel that receives glazing to hold the upper edge of the windowpane 118. The sash 130 defines a spring seat 132 and a pivot groove 134. A latch leaf 136 includes an arcuate projection 138 that engages the pivot groove 134. A spring 140 bears between the spring seat 132 and the latch leaf 136 to bias the spring leaf into engagement with the lip 92 of the latch keeper 90.

As illustrated in FIG. 3A, the opposing sides of the frame 15 in the stationary portion 16 are members identical to the lower frame member 52 with the channel 68 receiving glazing to hold side edges of the windowpane 72. As illustrated in FIG. 3B, the opposing sides of the frame 15 in the movable portion 18 are members identical to the upper frame member 54. In summary, the inner window assembly 12 of the non-egress window 10 in the illustrated embodiment provides both a fixed windowpane portion generally 16 and the pivotably openable windowpane portion generally 18. An alternate embodiment of the non-egress window includes only a fixed windowpane portion by eliminating the divider bar 20 and the pivoting transom structure.

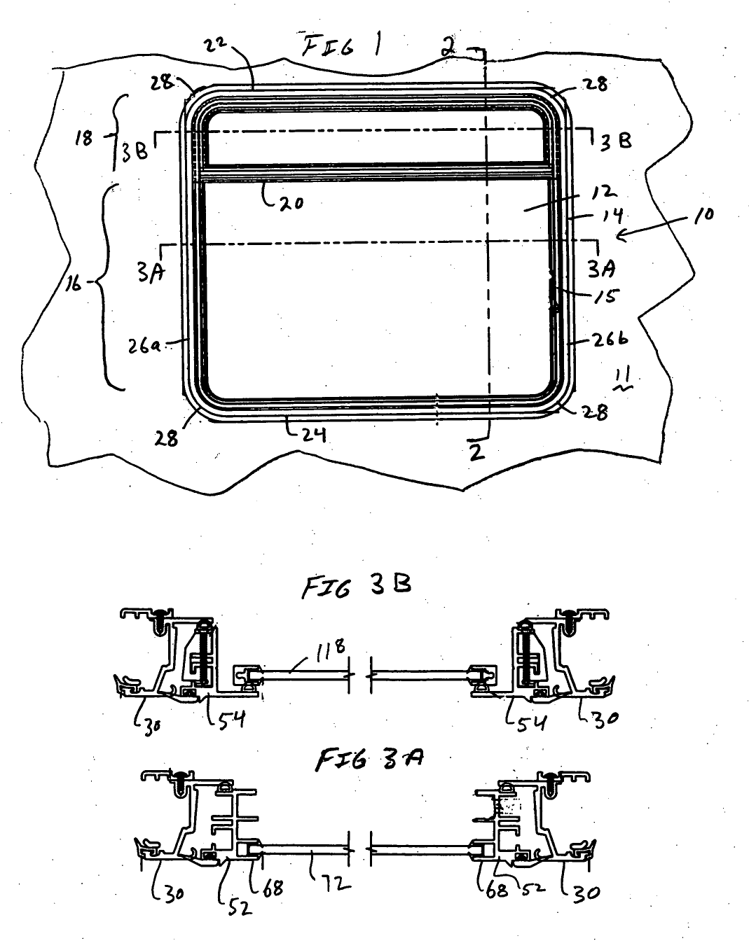

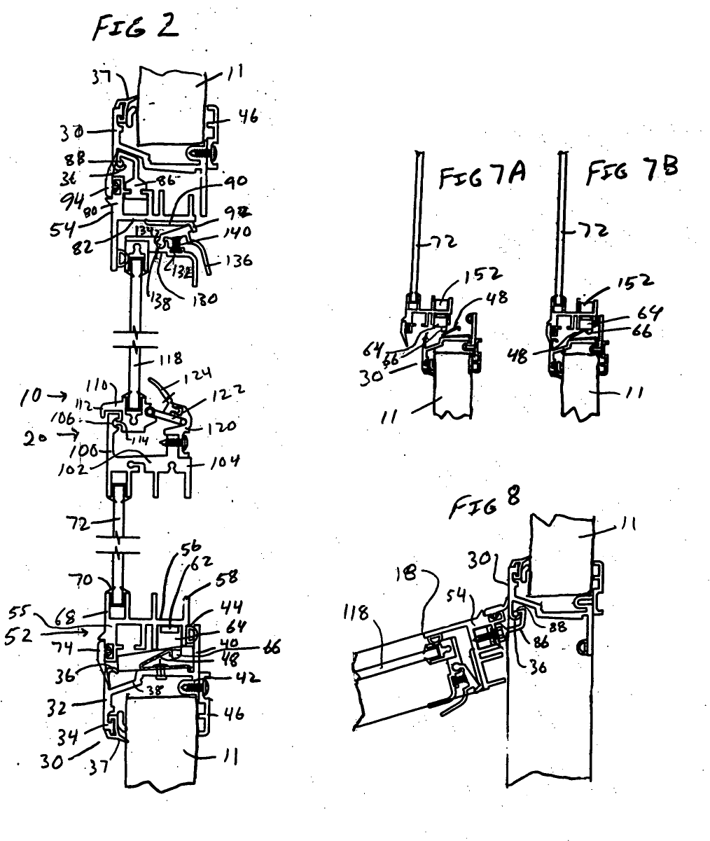

FIG. 4 is a detailed cut-away view of the lower portion 22 of the frame 14 of the non-egress window 10 illustrated in FIG. 1. Guides 150 support the release bar 62 and permit longitudinal movement of the release bar. The release bar 62 attaches to the base 56 at a first distal end with a spring 150. The spring 150 biases the release bar 62 to a first position with the latch catches 64 aligned with and engaged to a respective one of the latch keepers 48. The lower frame member 52 defines an opening to the recess that receives the release bar 62. A cap 151 selectively closes the opening, and can be fixed with a lock to prevent unauthorized access to the release bar. A release actuator 152 is disposed in the opening and attaches with a threaded fastener 153 to the release bar 62. The release actuator 152 defines a hole 154 that provides access to the threaded fastener that engages the release bar 62.

FIGS. 5A and 5B are top views of the frame member 52 and the release actuator 152. FIG. 5A illustrates the release actuator 152 in the first position with the latch catches 64 aligned with and engaged to a respective one of the latch keepers 48. FIG. 5B illustrates the release actuator 152 in the second position. In this position, the latch catches 64 have been moved out of engagement with the latch keepers 48.

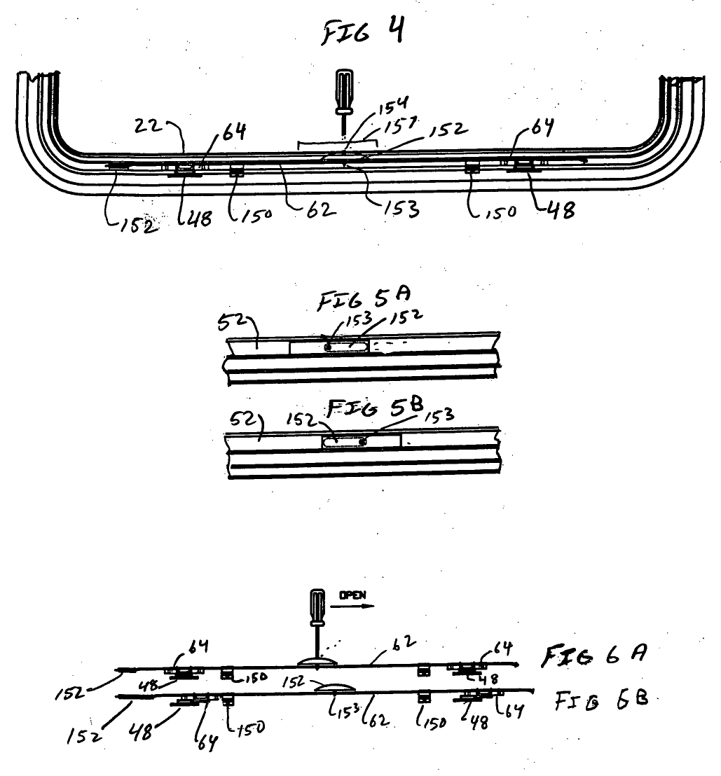

FIGS. 6A and 6B are schematic side views of the release bar 62 and the release actuator 152. FIG. 6A illustrates the release bar 62 and the release actuator 152 in the first position with the latch catches 64 aligned with and engaged to a respective one of the latch keepers 48. A tool is illustrated received in the hole in the release actuator 152. FIG. 6B illustrates the release bar 62 and the release actuator 152 in the second position with the latch catches 64 moved out of engagement with the latch keepers 48.

FIGS. 7A and 7B illustrate the engagement of the non-egress window 10 to the frame member 30. With reference to FIG. 7A, the window is attached at the upper end to the frame by engaging the hook 88 with the hook 36 of the upper frame member 54, as illustrated in FIG. 8. The lower portion of the window swings inwardly. The protrusion 66 of the latch catch bears against the latch keeper 48. As the window pivotingly moves inwardly, the distal end of the protrusion slips over and catches inwardly of the latch keeper 48, thereby locking the window to the frame 14 in the closed position as shown in FIG. 7B.

The non-egress window 10 is readily installed or removed for servicing of the window or replacement of the glass 72, 118, or other purpose. With reference to FIGS. 4 5A, and 6A, a tool is used to move the release bar 62. This is accomplished by first removing the cap 151 and using a screwdriver configured for engaging the head of the threaded fastener or screw in the release actuator 152. The tip of the screwdriver inserts into the hole in the release actuator 152. The screwdriver is rotated to loosen the screw 153 that holds the release bar 62 fixed from movement by the release actuator tightly in the opening in the frame member 52. When the release actuator 152 is released, the screwdriver is pushed laterally to move the release actuator and thus move the release bar 62 from the first position to a second position. During the longitudinal movement of the release bar 62, the latch catch 64 clears from engagement with the respective latch keeper 48, as illustrated in FIG. 6B. The window 10 can then be pushed outwardly at the bottom to detach the lower frame member 52 from the member 30 in the frame 14, similar to that shown in FIG. 7A. Releasing the lateral force on the release actuator 152 allows the spring 150 to pull the release bar 62 to the first position. The window 10 is removed by disengaging the hook 88 from the hook 36, such as by sliding the window (pivoted outwardly from the sidewall of the transit vehicle) laterally relative to the frame 14.

Upon reinstallation of the window 10, the threaded fastener in the release actuator 152 is tightened to lock the release bar 62 in the first position. The window 10 pivotally attaches to the frame 14 by sliding the window so that the hook 88 engages the hook 36. As illustrated in FIG. 7A, the lower portion of the window 10 is then pressed firmly in the lower portion to move the latch catches 66 into engagement with the latch keepers 48, as illustrated in FIG. 7B.

This specification has described the present invention that provides a non-egress window for a transit vehicle readily removed for serving, including the steps necessary for making and using various embodiments thereof. It is to be understood, however, that numerous changes and variations may be made in the construction of the present hard cover product within the spirit and scope of the present invention, and that modifications and changes may be made therein without departing from the scope thereof as set forth in the appended claims.

What is claimed is:

1. A non-egress window for motor vehicles selectively removable for servicing, comprising:
an exterior frame for mounting in an opening in a sidewall of a motor vehicle;
a connector attached to the exterior frame;
a window frame selectively attached to the connector and including a glazing that holds a window pane;
a pair of latch keepers mounted in spaced-apart relation to the exterior frame opposing the connector;
a release bar mounted in the exterior frame opposing the connector for selectively moving between a first position and a second position relative to the latch keepers by a tool selectively brought into contact therewith; and
a pair of latch catchers attached to the release bar and engagable to the latch keepers with the release bar in the first position and disengaged therefrom with the release bar in a second position.

2. The non-egress window as recited in claim 1, further comprising a release actuator associated with the release bar for engaging the tool to move the release bar between the first position and the second position.

3. The non-egress window as recited in claim 2, wherein the release actuator comprises a slot in the release bar engagable by the tool for moving the release bar.

4. The non-egress window as recited in claim 3, wherein the window frame defines an opening aligned with the release actuator; and further comprising a removable cap to access the opening with the tool to move the release bar.

5. The non-egress window as recited in claim 4, further comprising a securing member movable between a locked position restricting access to the release bar and an unlocked position enabling access thereto.

6. The non-egress widow as recited in claim 5, wherein the securing member comprises a threaded member extending through the cap and movable between a locked position restricting removal of the cap and an unlocked position allowing removal of the cap.

7. The non-egress window as recited in claim 1, wherein the connector comprises an elongate member for pivotally supporting the window frame, whereby the window frame engages the exterior window frame at a first angle for insertion and removal of the widow frame from the exterior window frame and pivots to a second angle receiving the window frame substantially coplanar within the exterior window frame.

8. The non-egress window as recited in claim 7, further comprising a hinge member attached to a portion of the window frame for pivotally engaging the connector.

9. The non-egress window as recited in claim 1, wherein the window frame defines an opening aligned with a portion of the release bar; and further comprising a removable cap to access the opening with the tool to move the release bar.

10. The non-egress window as recited in claim 9, further comprising a securing member detachably engaged to the cap to restrict removal thereof and movable between a locked position and an unlocked position.

11. The non-egress window as recited in claim 10, wherein the securing member comprises a threaded fastener.

12. The non-egress window as recited in claim 1, further comprising a biasing member attached to the release bar biasing the release bar to the first position.

13. The non-egress window as recited in claim 12, wherein the biasing member comprises a spring attached at one end to the release bar and at an opposing end to the exterior frame.

14. The non-egress window as recited in claim 13, wherein the window frame defines an opening aligned with a portion of the release bar, for passing a tool therethrough to move the release bar from the first position to the second position.

15. A non-egress window for motor vehicles selectively removable for servicing, comprising:
an exterior frame for mounting in an opening in a sidewall of a motor vehicle;
a connector attached to the exterior frame;
a window frame selectively attached to the connector and including a glazing that holds a window pane
a pair of latch keepers mounted in spaced-apart relation to the exterior frame opposing the connector;
a release bar mounted in the exterior frame opposing the connector and selectively moveable relative to the latch keepers;
the window frame defining an opening aligned with a portion of the release bar with a removable cap to access the opening with a tool for moving the release bar; and
a pair of latch catchers attached to the release bar and engagable to the latch keepers with the release bar in the first position and disengaged therefrom with the release bar in a second position.

16. The non-egress window as recited in claim 15, further comprising a release actuator associated with the release bar for engaging the tool to move the release bar between the first position and the second position.

17. The non-egress window as recited in claim 16, wherein the release actuator comprises a slot in the release bar engagable by a tool for moving the release bar.

17. The non-egress window as recited in claim 16, further comprising a securing member movable between a locked position restricting access to the release bar and an unlocked position enabling access thereto.

18. The non-egress widow as recited in claim 17, wherein the securing member comprises a threaded member extending through the cap and movable between a locked position restricting removal of the cap and an unlocked position allowing removal of the cap.

19. The non-egress window as recited in claim 15, wherein the connector comprises an elongate member for pivotally supporting the window frame, whereby the window frame engages the exterior window frame at a first angle for insertion and removal of the widow frame from the exterior window frame and pivots to a second angle receiving the window frame substantially coplanar within the exterior window frame.

20. The non-egress window as recited in claim 19, further comprising a hinge member attached to a portion of the window frame for pivotally engaging the connector.

21. The non-egress window as recited in claim 20, further comprising a securing member detachably engaged to the cap to restrict removal thereof and movable between a locked position and an unlocked position.

22. The non-egress window as recited in claim 21, wherein the securing member comprises a threaded fastener.

23. The non-egress window as recited in claim 15, further comprising a biasing member attached to the release bar biasing the release bar to the first position.

24. The non-egress window as recited in claim 23, wherein the biasing member comprises a spring attached at one end to the release bar and at an opposing end to the exterior frame.

25. A method of removing a non-egress window from a sidewall of a motor vehicles for servicing, comprising the steps of:
(a) removing a cover that closes an opening in a window frame, which opening is aligned with a portion of a release bar mounted therein, the release bar having a latch catcher that in a first position is engaged with a latch keeper mounted to an exterior frame in an opening in a sidewall of a motor vehicle;
(b) contacting the release bar with a tool inserted through the opening;
(c) moving the release bar with the tool to a second position relative to the latch keeper to disengage the latch catcher; and
(d) pivoting the widow frame from the exterior frame.

26. The method as recited in claim 25, further comprising prior to step (a) removing a locking member that secures the cover in place relative to the opening.
